(19) United States
(12) Patent Application Publication
(10) Pub. No.: US 2008/0302227 A1
(43) Pub. Date: Dec. 11, 2008

(54) Method For Straining and Steering of a Blade in a Saw Device and Steering and Straining Devices

(76) Inventor: Reijo Viljanen, Kolsva (SE)

Correspondence Address: STITES & HARBISON PLLC, 1199 NORTH FAIRFAX STREET, SUITE 900, ALEXANDRIA, VA, 22314, US

(21) Appl. No.: 11/997,373

(22) PCT Filed: Aug. 1, 2006
(86) PCT No.: PCT/FI2006/000268

§ 371 Date: Jun. 18, 2008

(30) Foreign Application Priority Data
Aug. 1, 2005 (FI) 20050790

(51) Int. Cl. B26D 1/48

(52) U.S. Cl. 83/820; 83/817

(57) ABSTRACT

A method to strain a sawing device blade (1) made of magnetic material to a chosen sawing line and to steer it to stay on said line. By means of elements (6), a sawing tightness is strained to blade (1) in moving said blade sidewise to the chosen sawing line, the said sawing line is formed in a sawing portion between said elements (6), and by means of said elements (6), blade (1) is continuously effected during sawing in order to adjust the portion intended for the sawing line of blade (1) to stay on the said sawing line.

The invention relates to a method and devices to strain a sawing device blade made of magnetic material, to a chosen sawing line and to keep it on said line. The sawing device is a circular saw or a band saw.

Previously known from the published Swedish application 436 849 is a system working by means of magnetic forces in order to position the blade to remain on a chosen sawing line. If the blade stays on line no magnetic forces are conducted to he blade. When the blade moves aside from line one tries to return the blade to the line by means of magnetic forces. Stated in the publication is that the same invention can also be applied to a band saw band-knife

Presented in publication WO 00/47378 is the control of a band saw band-knife by means of magnetic forces, when inside the object to be sawn, deviation of blade from the chosen sawing line is observed. The band-knife is, if needed, turned inside the object to be sawn by means of magnetic forces in order return it to the sawing line.

Above described control and stability arrangements of the blade of magnetic material mainly work only when deviation of blade from the sawing line has been noticed and by means of them one tries to improve the quality of sawing in trying to steer the blade inside the tree to the sawing line. Known in band saws are mechanical drags or rolls, which are close to the object to be dragged and usually at once thereafter in the blade direction These drags and rolls, in present band saws, determine the sawing line. In publication SE 436849 adjusting bits are replaced with magnets which are placed on both sides of the circular saw close to the blade immediately before the tree to be sawn and thereafter. With these ones it is tried to steer the blade to stay on the chosen line, even if the tree to be sawn would, due of its non-uniformity, try to turn the blade. Due to thermal expansion these do not prevent the bending to wave form and wave-like rolling of the blade, since they are on the same diameter line. The wave form only seeks the amplitude point to these points and the blade continues to roll fluttering.

The above invention is focused to replace the mechanical drags or rolls of band saws and the invention is characterized in that in the method by means of elements generating magnetic forces into a blade, by moving said blade sidewise to the chosen sawing line, the said sawing line is formed on the sawing portion between the said elements and the blade is continuously affected with the impact of said elements during sawing in order to regulate the portion meant for the blade to stay on the said sawing line.

The devices according to the invention are characterized in that the devices include magnetic elements that generate magnetic forces, by means of which the blade of the sawing device can by sidewise motion be strained to the chosen sawing line, while said sawing line is formed between said elements, the control devices for continues adjustment of the magnetic forces of the elements working during sawing with the intention to make the portion, meant for the blade sawing line, stay on the sawing line.

The method according to this invention for steering the blade of magnetic material to stay on the sawing line by means of elements generating magnetic forces or by means of elements generating sidewise motions is characterized in that in the method several element pairs are used, which pairs are placed close to the blade on different sides in regard to the object to be sawn on portions on opposite sides of the blade, as in a circular saw blade in an angle of 180° and in a band saw on the portions of its blade running in different directions and magnetic forces or sidewise motions generated by said elements are adjusted depending on each other so that the adjustment process carried out by the other member of the pair is facilitated, while by simultaneous or by substantially simultaneous adjustment of the other member of the pair is facilitated.

The advantage of the invention is that in band saws harmful drags can be replaced with untouchable pulling magnets or pushing magnets, whereby many handicaps caused by the use of drags can be avoided. The drags tear and cause excess friction to band rotation and also generate heat into band. Forces caused by magnets do not wear and tear the band, they keep their position and adjustment of band position, in other words, the distance is easily adjusted from the magnet. Also heat impacts on the band remain minor. In another embodiment of the invention the drags are preserved but the forces directed on them are substantially reduced in preserving the magnetic forces b y means of the mechanical dragging forces to quite small, at least under 50% of the total sidewise motion force.

The position of a band saw blade-knife adjusted with magnets can in different stress situations be kept in place in spite of different circumstances tending to change the straining pollution that for different reasons is directed on the blade.

In order to prevent the tendency of the circular saw into wave form one can with the dependency of the adjustments of the magnetic devices to on each other better prevent the tendency of the knife-band into said wave-form appearing by rotation.

In the following the invention is disclosed with reference to the enclosed drawing, where

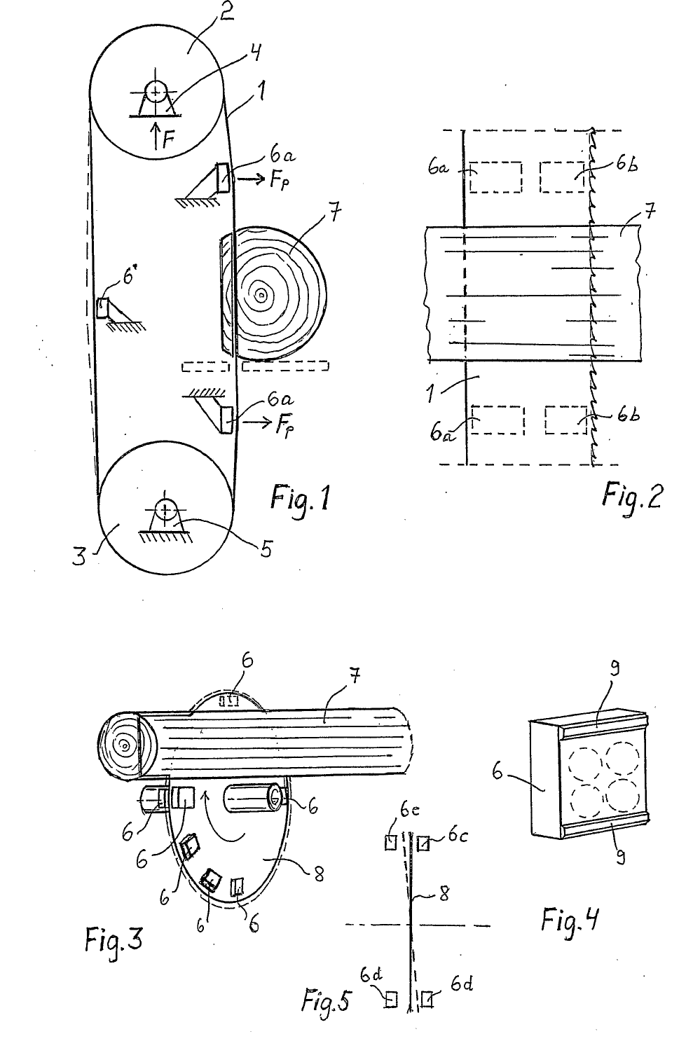

FIG. 1 shows a band saw from the side,

FIG. 2 shows the blade-knife of a blade saw as a part cut,

FIG. 3 shows a circular saw,

FIG. 4 shows an element,

FIG. 5 shows the blade of a circular saw from one end.

FIG. 1 shows a conventional band saw, which has a band-knife 1 circulation arrangement around two wheels 2 an d 3. Bearing spot 4 of wheel 2 can be moved and to it a force F is directed by use in order to get the pre-tightness just right. The bearing spot 5 of wheel 3 can be fixed. In the sawing spot, on which the tree 7 is placed, the band-knife 1 is pulled out a little from the straight line between the peripheries of wheels 2 and 3. With this pull out a sawing line is formed, which is meant to be retained all the timeduring sawing. In the method according to this invention this line is formed by means of elements 6 (in figure), thanks to push forces Fp of which the band-knife 1 is deviated a little outward on the area between elements 6. In known solutions there are drags or rolls. The elements are magnets, due to which the band-knife 1, magnetized to same polarity, tends to get loose from elements 6 The final stretching force is thus formed of the force generated by the sidewise motion of band-knife 1 on band-knife by means of magnets 6a, 6b. In each element 6 there are also a distance detector to observe the position band- knife 1.

In another embodiment elements 6 are placed in regard to the solution of FIG. 5 on the other side of band-knife 1 and with their pulling force the band-knife 1 is moved sidewise accordingly to the sawing line. In one embodiment the band-knife 1 is moved sidewise into the device either by means of pulling or pushing magnets.

The repulsion force or pulling force is chosen to such kind that the band saw stays apart from element 6. Elements 6 are, as to their force, most suitably electronically controlled electric magnets. In connection with the element it is easy to join a distance detector either mechanic or electronic, whereby the repulsion force or pulling force of the magnet is quickly adjustable when the distance of the of the band-knife from the element is changing. The distance may change a little, if, for instance the quality of the tree 7 to be sawn becomes knotty, which increases the need of pushing/pulling force.

The necessary pulling or pushing force Fp of elements 6 is quite small compared with the straining force forming in the blade. For instance, it can be the 50^{th}-200^{th} part of the straining force.

It is possible to have a mechanical drag 9 or a roll in connection with magnetic elements 6, as shown in FIG. 4, either so that by means of magnetic forces the blade is adjusted to stay away from them, or an untouchable blade control is arranged, or so that the drags or rolls are in contact with the blade, but their contact force is substantially relieved by means of the magnets. The substantial relief is for instance over 50%. Then the sawing is not totally stopped, even if the magnetic control would of some reason get lose. The drags or rolls are either in connection with the elements or they are separately beside the elements, whereby they can be moved, for instance regardless of wearing.

FIG. 2 shows a knife-band according to FIG. 1 seen from the side. The breadth of the a knife-band is for instance 60-200 mm. The broad blade allows many elements 6 side by side. Then a possible turn of the blade direction is easily corrected. when there are separate adjustments for the side by side elements 6a and 6b. The blade can also be turned, turning it with the different mutual adjustment of these elements. There can be elements either those merely rejecting the blade-knife or merely pulling the blade-knife. Naturally, in both cases installation is made on both sides of the appropriate knife-band.

Both element types can also be in use at the same time on different sides of the band-knife.

Besides the band-knife 1 there is in FIG. 1 an additional straining magnet 6′, which is placed between wheels 2 and 3 on the return side of knife-band 1. When due to the tree a divergent load gets in the blade (especially a sudden one) or the blade gets longer because of warming or of use, the degree of straining of blade 1, whereby the distance in regard to straining magnets 6a and 6b also changes. This change moves the sawing line of the blade 1 and this cannot be allowed. In order to prevent this and quickly react to it, the adjustment of additional magnets 6′ has been made dependent on the adjustment of magnets 6a and 6b, and especially indication of distance from magnets 6a, 6b so that when the strain of blade 1 decreases distance does not be preserved in spite of the adjustment of magnets 6a,6b, magnet 6′ stretches band 1 to its original tightness so that the distance of blade 1 from stretching magnets 6a and 6b remains original. When the tightness of blade 1 increases, magnet 6′ reduces its tightness accordingly. Thus the adjusting devices of magnets 6a ,6b and 6′ work as independent pairs of each other. In this way possible contact of blade 1 with elements 6, and harmful loosening of the blade are avoided, and it is possible especially to maintain the distance of blade 1 from the straining magnets just right.

Instead of additional magnet 6′, by adjustment of the blade 1 tightness, as pair of magnets 6a, 6b can also in an embodiment the mechanical shifting apparatus of bearing housing 4 of wheel 2 work including its whereby said adjusting arrangements are connected dependent on each other.

In an embodiment the adjustment of the blade 1 tightness by means of additional magnet 6′ or bearing housing 4 is made independently based on a sensor that measurer the blade tightness.

FIG. 3 shows a conventional circular saw 8, on the periphery of which elements 6 according to the invention are installed to prevent transitions from the calculated line appearing in the blade.

In this case, however, self the sawing line is not formed by means of the elements, but it is yet kept up. The sawing line is formed by the flatness of the circular saw. The flatness is maintained, for instance, by continuous control of elements 6.

FIG. 5 shows the circular saw blade 8 from the end. Due to the features of the circular saw 8, the motion of the blade sidewise, for instance in the upper edge, causes blade motion in opposite direction in the lower edge (FIG. 5). This takes place when the circular blade tends to get into wave form due to warming up, and also if the special quality of the tree leads the blade to the side ion the sawing spot. Therefore the stability of blade 8 can be especially improved according to the invention, when there are elements at least all together in four spots, for instance in the lower and upper edge and horizontally in the front and in the trail edge in regard to the distance of the edge. Especially in the case of the circular saw it is possible by means of the magnetic forces of the magnetic elements 6 to keep the circular blade 8 centralized all the time. Drags 9 and rolls can also in the case of the circular saw be accordingly in contact with blade 8 all the time but relieved by means of the magnets as described above in the case of the band saw.

According to FIG. 5 of the element pairs 6c and 6d, one is in the upper edge and the other one in the lower edge. The control of these ones is made dependent of each other so that when the distance sensor of the member of the other pair, for instance of 6c, observes the motion of blade 1, immediately the control of magnetic force of this is given both to element 6c in question and also to element 6d of the opposite side. Thanks to the electronic apparatus the control is so fast that on the opposite side the next motion can be anticipated and it can, with magnetic counter force be at least partly be compensated away to the other side. It is advantageous in connection with bade 8 of the circular saw that there is at least two pairs of elements adjusted in this way, which most suitably work crosswise on the diameter lines in regard to each other. There is in connection with band saw blade 1 at least one pair, the other magnetic member 6′ of which or the shifting arrangement of bearing housing 4 is on the portion that runs in other direction than the one where the sawing takes place.

FIG. 4 shows a an element 6, on the edges of which there are a little frictional elevations 9 against which blade-knife 1 is gliding, if it for some reason gets too close to the element. The elevations are for instance 0.5 mm high from the element surface. As described above the drags can be arranged to work relieved even in continues connection with the blade

1. A method to strain a sawing device blade (1) made of magnetic material to a chosen sawing line and to steer it to stay on said line, characterized in that by means of elements (6), which generate magnetic force to blade (1), a sawing tightness is strained to blade (1) in moving said blade sidewise to the chosen sawing line, the said sawing line is formed in a sawing portion between said elements (6), and by means of said elements (6), blade (1) is continuously effected during sawing in order to adjust the portion intended for he sawing line of blade (1) to stay on said sawing line.

2. A method according to claim 1, characterized in that blade (1) is strained with magnetic element (6′) placed outside the sawing line or with sidewise motion of element (4), by means of which blade (1) is deviated sidewise, and the magnetic force or shifting force/motion of which element is controlled dependent on the observed position of blade (1) in regard to the chosen sawing line.

3. A method according to claim 1, characterized in that the magnetic force of element (6′) that tightens the blade and is placed outside the sawing line and the position of bearing housing (4) are controlled dependent on the degree of the tightness observed in (blade (1).

4. A method according to claim 1, characterized in that elements (6) are placed in regard to blade (1) before and after the object (7) to be sawn.

5. A method according to claim 1, characterized in that with elements (6) a force pushing (blade (1) away from or a force pulling it against the elements is caused.

6. A method according to claim 1, characterized in that there are elements (6) at least two side by side in the blade direction and they are separately adjusted, when the blade direction is changed into the wanted one.

7. Control and straining devices in order to strain blade (1), made of magnetising material, to a chosen line and to steer it to stay on the said line, characterized in that the devices include elements (6) generating magnetic force, by means of which blade (1) can be strained to the chosen sawing line by sidewise motion, the said sawing line formed between said elements (6), the control devices for continuous adjusting of the magnetic forces of elements (6) during sawing, with the intention to adjust the portion meant, for the sawing line of blade (1, to stay on the sawing line.

8. Devices according to claim 7, characterized in that elements (6) pushing and or/pulling closer to blade (1) are placed in regard to blade (1) in the front and in the back of the object to be sawn.

9. Devices according to claim 6, characterized in that there are many elements (6) side by side in the in the lateral direction of blade (1).

10. A method to steer blade 8 of a sawing device, the blade made of magnetizing material, to stay on a chosen sawing line by means of elements (6);(4) generating magnetic force or sidewise motion, characterized in that in the method several element pairs are used (6a, b); (6b′); (6a, b), (4) or (6c),(6d), which pairs are placed close to blade (1),(8) in regard to the object (7) to be sawn, on its different sides or on portions opposing the blade (1),(8) directions, as in a circular saw in an angle of 180° and in the band saw on portions of blade (1) in different directions, and magnetic forces or sidewise motions generated by means of said elements are adjusted dependent on each other so that the adjusting process carried out by the other member of the pair is facilitated by means of simultaneous or substantially simultaneous adjustment.

11. A method according to claim 10, characterized in that at least magnetic elements (6) are by means of the magnetic force steered to continuous impact on blade (1);(8).
